(19) United States
(12) Patent Application Publication
(10) Pub. No.: US 2014/0379430 A1
(43) Pub. Date: Dec. 25, 2014

(54) APPLICATION OF MOBILE DEVICES FOR EVENT DATA

(71) Applicant: International Business Machines Corporation, Armonk, NY (US)

(72) Inventors: Barry A. Kritt, Raleigh, NC (US); Sarbajit K. Rakshit, Kolkata (IN)

(21) Appl. No.: 13/921,885

(22) Filed: Jun. 19, 2013

(51) Int. Cl. G06Q 30/02

(52) U.S. Cl. CPC G06Q 30/0205
USPC 705/7.34

(57) ABSTRACT

Predicting a future behavior through extraction of data from a mobile device within a geo-coordinate boundary. A geo-coordinate boundary of a geographic locale is ascertained. The geo-coordinate boundary may be defined according to a detected or known event. Data associated with a mobile device is gathered within the ascertained geo-coordinate boundary, the data including demographic information associated with the mobile device. The data is gathered and analyzed such that at least one common trait among the data is identified. A future behavior is predicted based on the identified common trait(s), wherein the future behavior may include predicating traffic based on a mobile device user leaving the geo-coordinate boundary, or purchasing behavior of a mobile device user.

### BACKGROUND

1. Technical Field

The present invention relates generally to acquiring data through a mobile device. More specifically, the invention relates to gathering demographic data for mobile devices within specified geo-coordinate boundaries and predicting behavior through analysis of the data.

2. Background

Mobile communication devices having multi-functional capabilities, also known as smart phones, are becoming increasingly more prevalent. These devices generally include a processing unit that enables expanded capabilities. One such capability includes the ability to receive and transmit data across a network. Some mobile devices are equipped with global positioning system (GPS) tracking capabilities, enabling location sensitive data to be transmitted and received. The GPS capabilities identify and define the location of the device based on coordinate boundaries which enables the device to provide location data, instructions to a destination, and location sensitive information.

### SUMMARY OF THE INVENTION

This invention comprises a method, system, and computer program product for behavioral analysis.

In one aspect, a method is provided for analyzing geographic boundary data to predict a behavior pattern. Geo-coordinate boundary data of a locale is acquired. Data associated with a mobile device detected within the acquired boundary data is gathered. The gathered data includes demographic information associated with an owner of the detected mobile device. The gathered data is analyzed, and a future behavior of the owner is predicted based on at least one characteristic associated with the demographic information.

In another aspect, a computer program product is provided geo-coordinate boundary data analysis for behavior pattern prediction. Specifically, a computer program product is provided for use with one or more mobile devices. The program product comprises a computer readable storage device having program code embodied therewith. When executed, a processor executes the program code such that geo-coordinate boundary of a locale is acquired. Data associated with the one or more mobile devices detected within the acquired boundary is gathered. The gathered data includes demographic information associated with an owner of the detected mobile device. The program analyzes the gathered data, and predicts a future behavior based on at least one characteristic associated with the demographic information.

In yet another aspect, a system is provided for use with one or more mobile devices. The system includes a processing unit in communication with memory and a functional unit in communication with the processing unit. The functional unit includes tools in the form of managers to support behavioral analysis. The tools include, but are not limited to, a coordinate manager, a storage manager, an analysis manager, and a behavior manager. The coordinate manager is provided to ascertain geo-coordinate boundary data of a locale, and the storage manager functions to gather data associated with a mobile device detected within the ascertained boundary data. The data gathered by the storage manager includes demographic information associated with an owner of the detected mobile device. The analysis manager functions to analyze the gathered data and the behavior manager functions to predict a future behavior of the owner based on the analysis and at least one characteristic associated with the demographic information.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart illustrating a method for event detection.

FIG. 2 is a flow chart illustrating a method for gathering data from mobile device(s) for predicting future behavior patterns.

FIG. 3 is a flow chart illustrating a method for gathering data from mobile device(s) and predicting future behavior based on the detected event.

FIG. 4 is a flow chart illustrating a method for predicting future behavior patterns.

FIG. 5 is a block diagram illustrating a system for predicting future behavior based on demographic information gathered from a mobile device.

FIG. 6 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of managers, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

It is understood that groups of people gather for events, such as an athletic event, a concert, etc. Events can be scheduled or unscheduled. An event gathering location may be defined by GPS coordinates and a coordinate boundary. The event may also be time specific with a start time and an end time. The event may or may not be predefined. For a pre-defined event, the event may have a predefined location and time, such as a known athletic event at an arena or a concert performance etc. For an event that is not predefined, an event boundary may be detected based on characteristics of a gathering, such as an area having a larger than usual number of detected mobile devices at a particular time.

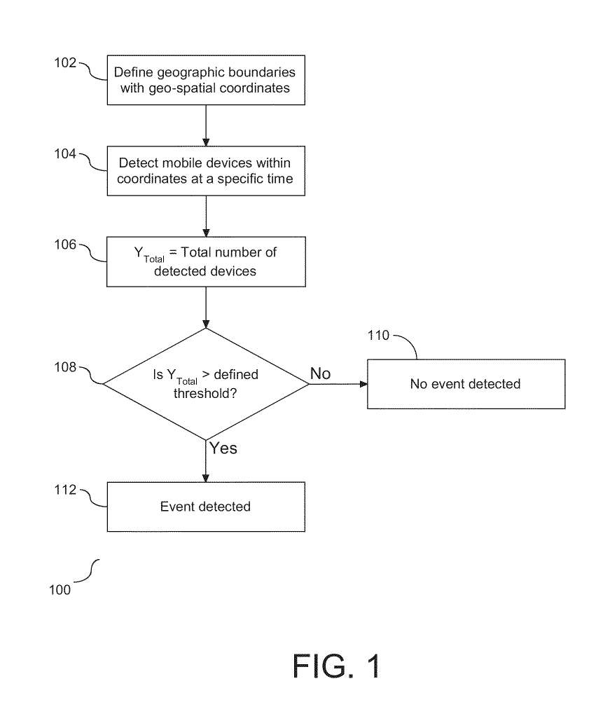

FIG. 1 is a flow chart (100) illustrating a method for detecting an event, such as a scheduled event. A location is set for detection. Specifically, an area for detection is defined by geographic boundaries with geo-spatial coordinates (102). Within a specific time-frame, mobile devices are detected within the boundaries of the geo-spatial coordinates (104). The variable Y_{Total} is assigned to the total number of detected devices within the time-frame (106). To be considered an event, a threshold defining a minimum quantity of devices should be met. In the case of mobile devices equipped with GPS capabilities, a minimum number of such devices within the boundary limits need to be detected. Following step (106), it is determined whether Y_{Total} is greater than a defined threshold (108). A negative response is followed by the determination that no event was detected (110), while a positive response implies the detection of an event (112). Accordingly, an event is captured when mobile devices are detected within a defined location such that the number of detected devices exceeds a defined threshold.

In one embodiment, an event may have a defined time interval. Specifically, the detection of GPS equipped devices may only be monitored for a limited time interval. In this embodiment, an event may be detected within a defined location and within a defined period of time. Accordingly, events may be time sensitive in addition to being location sensitive.

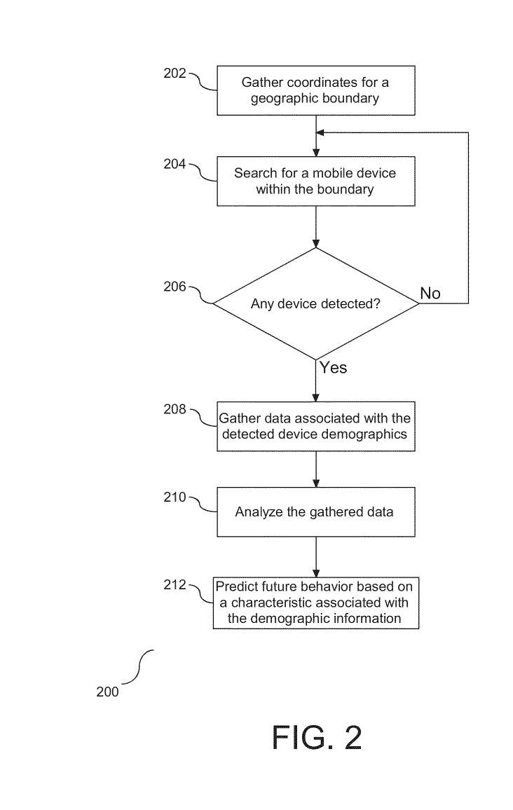

Data can be gathered from the detected mobile devices. From the gathered data, a predicted behavior pattern can yield a predicted future behavior pattern of an owner of the detected mobile device. FIG. 2 is a flow chart (200) illustrating a method for utilizing global position data to ascertain a common trait among mobile device users within a geographic locale. Specifically, a geographic area, also referred to herein as a target area, is selected. All geographic areas are defined by geographic boundary coordinates. A set of geographic boundary coordinates are gathered for a specified area (202). In one embodiment, the geographic boundary is defined through ascertainment of a geo-coordinate boundary of a geographic locale. In one embodiment, the geo-coordinate boundary is defined responsive to detecting an event as shown and described in FIG. 1. Once the area is defined, any device that is GPS equipped and is within the area can be detected. Accordingly, a GPS mobile communication device in the defined area can be detected and information from the device can be extracted.

Following step (202), a GPS equipped mobile device is searched for within the defined coordinate boundary (204). Following step (204), it is determined if any device was detected within the boundary (206). A negative response to the determination at step (206) is followed by a return to step (204), while a positive response is followed by gathering data associated with the detected device(s) (208). In one embodiment, the defined geo-coordinate boundary is sent to one or more mobile phone carriers and the mobile device carriers respond with the summarized data from the detected mobile devices within the defined boundary. In one embodiment, the device demographics relate to owner information of the device i.e. age-range, gender, residence, etc, as it is understood that such devices have an underlying registered owner. The gathered data is analyzed (210) to gather common characteristics among users or owners of the detected devices. Future behavior is predicted based on a characteristic associated with the demographic information (212), as described in greater detail below. Accordingly, data is gathered and analyzed from mobile devices, or other forms of GPS enabled devices, located in a defined area.

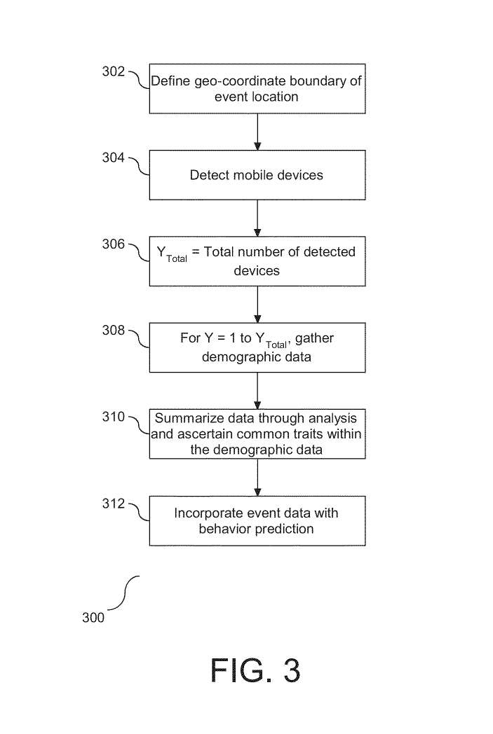

Either a predetermined or a detected event can be used to define a boundary for collecting mobile device data and predicting future behaviors. FIG. 3 is a flow chart (300) illustrating a method for incorporating event data with behavior predictions. An event is defined as a gathering within a locale or an area defined by GPS coordinates. All events take place at some location, which is defined by a geographic boundary. Subsequent to defining an event (302), GPS enabled devices, such as mobile communication devices, are detected within the event boundary (304). Variable Y_{Total} is assigned as the total number of detected devices (306). Demographic data is gathered for each detected mobile device within the event boundary (308). In one embodiment, multiple levels of information sharing may be available. The multiple levels include granting access to exclusively summarized demographic information, or access to individual demographic information associated with a mobile device. For example, in one embodiment, the demographic data is gathered responsive to access to the data granted by a user of a detected mobile device within the event boundary. In the embodiment where access to summarized demographic information is granted, the demographic data received from each detected mobile device is compiled and summarized through analysis such that common traits within the demographic data may be detected (310). The detected common traits, which in one embodiment are incorporated with the event data, may be used to predict future behavior (312). Accordingly, demographic data is gathered from mobile devices within an event boundary for analysis and for predicting future behavior.

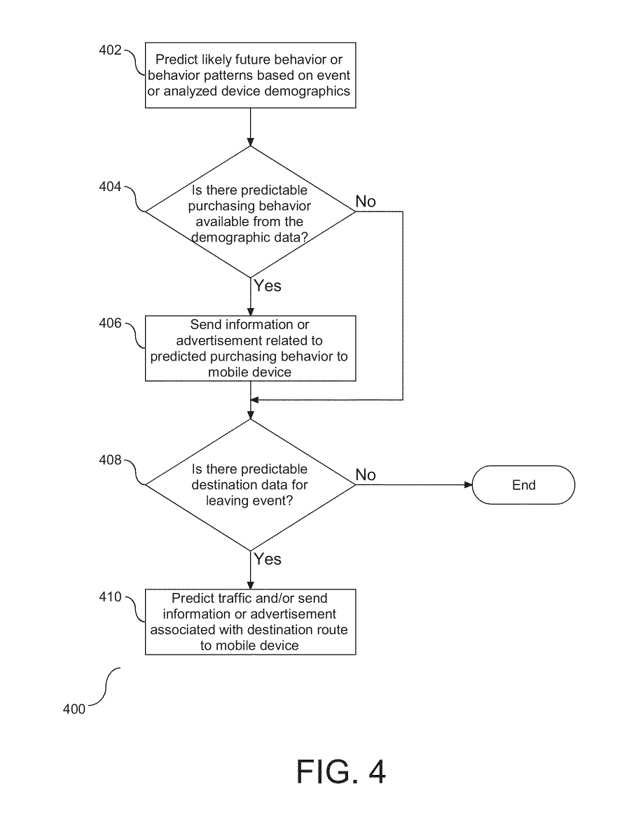

Predicting future behavior or behavior patterns is challenging. The future is unknown and difficult to quantify. Mobile communication devices offer a vast amount of data pertaining to human behavior and behavior patterns. Common traits are determined from the summarized mobile device demographic information, which may also be used as a factor to predict future behavior patterns and/or actions of users of the mobile devices. FIG. 4 is a flow chart (400) illustrating a method for utilizing the prediction of future behavior based on the determined common traits associated with demographic information from two or more mobile communication devices. For example, the common traits may be applied to studying traffic patterns and purchasing behavior. While FIG. 4 illustrates only two examples of predicted future behavior from determined common traits, the invention should not be limited to these examples. Likely future behaviors and/or behavior patterns are predicted based on analyzed device demographics (402). In one embodiment, the knowledge of the event is also incorporated into the prediction. Accordingly, predicted future behaviors are assessed based on determined common demographic traits from two or more communication devices.

It is determined if there is any predictable purchasing behavior available from the demographic data (404). A positive response is followed by sending product related information associated with the predicted purchasing behavior to at least one of the detected mobile devices (406). In one embodiment, the product related information is sent to the mobile device to be displayed in the form of a product advertisement. For example, if the summarized demographic information reveals that a majority of mobile device users within the coordinate boundary are over the legal age limit for drinking, an advertisement for related products over the legal age limit may be sent to one or more of the mobile devices. In one embodiment, where access is granted to individual demographic information associated with a mobile device, personal product related information may be sent to the mobile device. In one embodiment, where an event is known or detected, the advertisement may present a product associated with the event and/or an event demographic. Similarly, in one embodiment, the advertisement may direct a mobile device user to a location for purchasing within the event boundary. Accordingly, future behavior patterns are predicted based on determined common demographic traits and may be used for target advertising.

In addition to predicting purchasing behavior, traffic may be predicted through prediction of travel paths of mobile device users. It is determined if there is a predictable and common destination for users of the mobile device(s) leaving the event boundary (408). A negative response to step (404) is followed by a return to step (408). Additionally, a negative response to step (408) is followed by a termination of the method while a positive response is followed by predicting traffic associated with possible routes mobile users may take to arrive at the determined common destination. Specifically, traffic may be predicted by determining the route(s) mobile users must take from the geographic boundary area to the predicted destination. In one embodiment, the data collected by the mobile device(s) includes the residence of the mobile device user, such that traffic is predicted by assuming greater traffic congestion on common routes between the coordinate boundary and the likely destination of users. In one embodiment, the data collected from the device may include the intended route(s) of a user upon leaving the coordinate boundary, i.e. a following event entered into a calendar planner of a user, or a destination entered into a GPS system of the mobile device to determine the future path of the user from the geographic boundary. In one embodiment, where access is granted to individual demographic information associated with a mobile device, personal travel related information such as travel recommendations may be sent to the mobile device. Accordingly, analyzed data may be used to determine common traits or individual demographic information for targeted advertising or relaying information.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

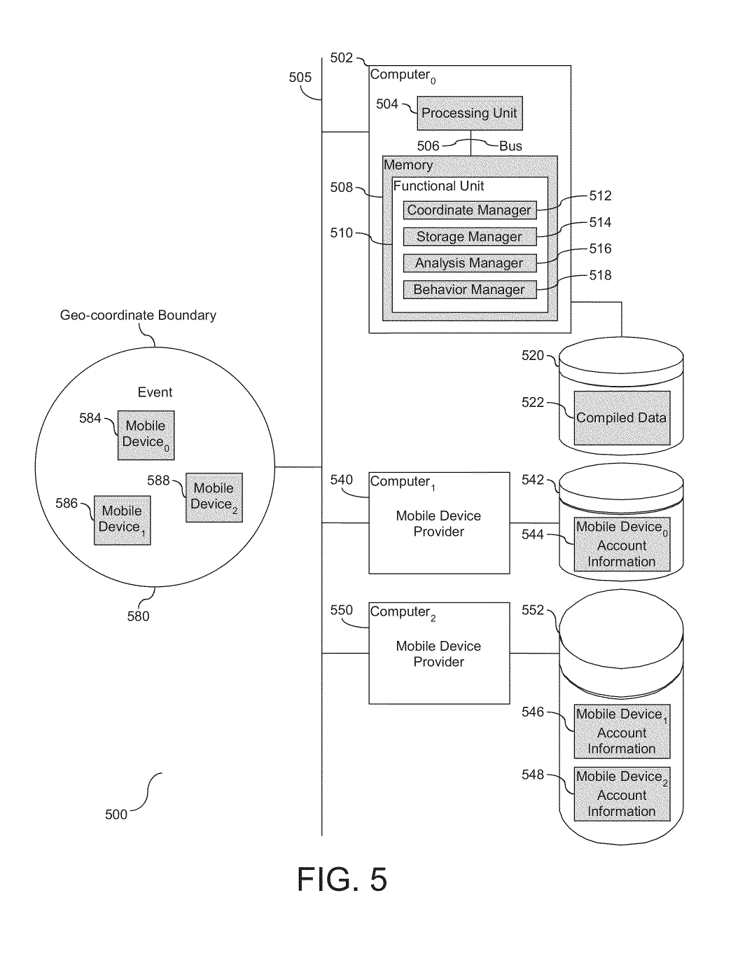

FIG. 5 illustrates a system (500) for predicting future behavior from mobile device data. A computer (502) is provided in communication with a network (505), and specifically with devices across the network (505) within a geographic boundary (580), as explained in further detail below. The computer is in communication with additional computer nodes (540) and (550) respectively, across the network. While only two additional nodes are depicted, any number of nodes may be implemented across the network. Each node is in communication with local data storage to store mobile device account information. Computer₁ (540) is shown in communication with data storage (542) having account information for mobile device₀ (544). Similarly, computer₂ (550) is shown in communication with data storage (552) having account information for mobile device₁ (546) and mobile device₂ (548).

The computer (502) includes a processing unit (504) in communication with memory (508) across a bus (506). A functional unit (510) is provided embedded in memory (508), and includes tools to support functionality associated with the hierarchical representation. The tools include, but are not limited to, a coordinate manager (512), a storage manager (514), an analysis manager (516), and a behavior manager (518). The coordinate manager (512) ascertains a geo-coordinate boundary of a geographic locale (580). In one embodiment, the geo-coordinate boundary (580) is established around an event as described in greater detail above. The storage manager gathers data associated with a mobile device within the ascertained geo-coordinate boundary (580). Mobile device₀ (584), mobile device₁ (586), and mobile device₂ (588) are shown as detected mobile devices within geo-coordinate boundary (580). While only three devices are shown, (584), (586), and (588), respectively, any number of mobile devices may be detected within the boundary (580). The gathered data includes demographic information associated with each mobile device. In one embodiment, the gathered data (522) is stored locally in data storage (520). In one embodiment, where the boundary encompasses an event, the storage manager gathers data associated with the event. Accordingly, the coordinate manager establishes coordinate boundaries for gathering mobile device data gathered by the storage manager.

The analysis manager, provided in communication with the coordinate manager, analyzes the gathered data. In one embodiment, the analysis comprises summarizing the gathered data by finding common demographic traits among the data of the mobile devices, (584), (586), and (588) respectively. In one embodiment, the analysis manager compiles common demographic traits that are associated with an event. The behavior manager (518) predicts a future behavior based on at least one characteristic associated with the demographic information. In one embodiment, the characteristic is a common demographic trait found among at least two mobile devices. In one embodiment, the future behavior comprises predicting traffic from demographic information involving predicted destinations of mobile users from the geographic boundary. In one embodiment, the future behavior comprises predicting purchasing behavior based on the demographic information. Accordingly, the analysis manager analyzes the gathered data and the behavior manager predicts a future behavior responsive to the analysis.

Furthermore, the described features, structures, or characteristics may be combined in any suitable manner in one or more embodiments. Examples of the managers have been provided to lend a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The functional unit described above in FIG. 5 has been labeled with managers. The managers may be implemented in programmable hardware devices such as field programmable gate arrays, programmable array logic, programmable logic devices, or the like. The manager(s) may also be implemented in software for processing by various types of processors. An identified manager of executable code may, for instance, comprise one or more physical or logical blocks of computer instructions which may, for instance, be organized as an object, procedure, function, or other construct. Nevertheless, the executable of an identified manager need not be physically located together, but may comprise disparate instructions stored in different locations which, when joined logically together, comprise the managers and achieve the stated purpose of the managers.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

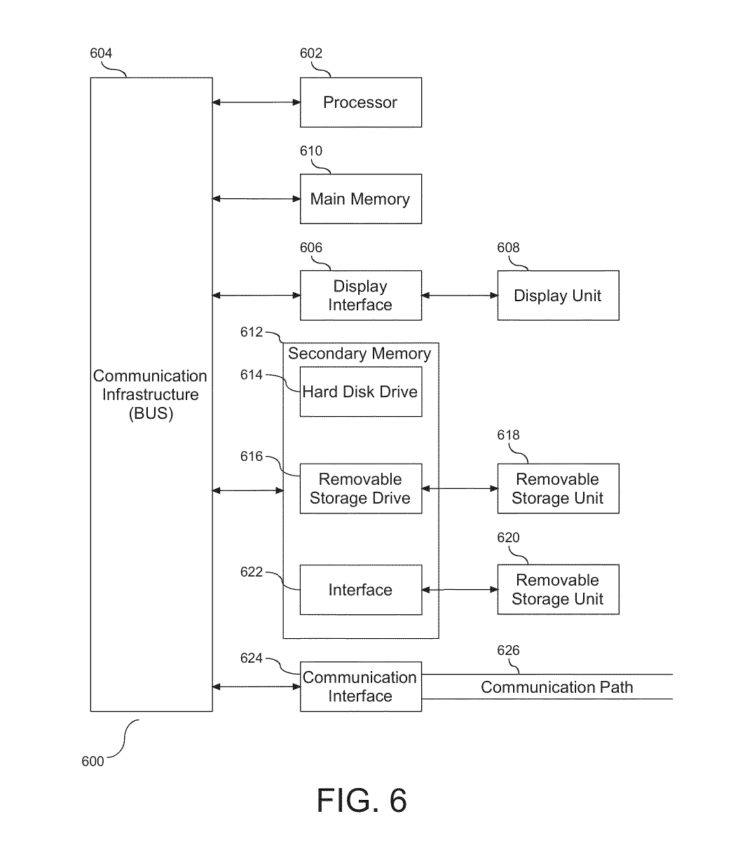

Referring now to the block diagram (600) of FIG. 6, additional details are now described with respect to implementing an embodiment of the present invention. The computer system includes one or more processors, such as a processor (602). The processor (602) is connected to a communication infrastructure (604) (e.g., a communications bus, cross-over bar, or network).

The computer system can include a display interface (606) that forwards graphics, text, and other data from the communication infrastructure (604) (or from a frame buffer not shown) for display on a display unit (608). The computer system also includes a main memory (610), preferably random access memory (RAM), and may also include a secondary memory (612). The secondary memory (612) may include, for example, a hard disk drive (614) (or alternative persistent storage device) and/or a removable storage drive (616), representing, for example, a floppy disk drive, a magnetic tape drive, or an optical disk drive. The removable storage drive (616) reads from and/or writes to a removable storage unit (618) in a manner well known to those having ordinary skill in the art. Removable storage unit (618) represents, for example, a floppy disk, a compact disc, a magnetic tape, or an optical disk, etc., which is read by and written to by a removable storage drive (616). As will be appreciated, the removable storage unit (618) includes a computer readable medium having stored therein computer software and/or data.

In alternative embodiments, the secondary memory (612) may include other similar means for allowing computer programs or other instructions to be loaded into the computer system. Such means may include, for example, a removable storage unit (620) and an interface (622). Examples of such means may include a program package and package interface (such as that found in video game devices), a removable memory chip (such as an EPROM, or PROM) and associated socket, and other removable storage units (620) and interfaces (622) which allow software and data to be transferred from the removable storage unit (620) to the computer system.

The computer system may also include a communications interface (624). Communications interface (624) allows software and data to be transferred between the computer system and external devices. Examples of communications interface (624) may include a modem, a network interface (such as an Ethernet card), a communications port, or a PCMCIA slot and card, etc. Software and data transferred via communications interface (624) are in the form of signals which may be, for example, electronic, electromagnetic, optical, or other signals capable of being received by communications interface (624). These signals are provided to communications interface (624) via a communications path (i.e., channel) (626). This communications path (626) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (610) and secondary memory (612), removable storage drive (616), and a hard disk installed in hard disk drive or alternative persistent storage device (614).

Computer programs (also called computer control logic) are stored in main memory (610) and/or secondary memory (612). Computer programs may also be received via a communication interface (624). Such computer programs, when run, enable the computer system to perform the features of the present invention as discussed herein. In particular, the computer programs, when run, enable the processor (602) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Specifically, the autonomous detection of a mobile device within a coordinate boundary is not limited to a mobile phone. Accordingly, the scope of protection of this invention is limited only by the following claims and their equivalents.

1. (canceled)

2. (canceled)

3. (canceled)

4. (canceled)

5. (canceled)

6. A computer program product for use with a first source having a first original format, the computer program product comprising a computer readable storage device having program code embodied therewith, the program code executable by a processor to:
ascertain a geo-coordinate boundary of a geographic locale;
gather data associated with a mobile device within the ascertained geo-coordinate boundary, the gathered data including demographic information associated with the mobile device;
analyze the gathered data; and
predict a future behavior based on at least one characteristic associated with the demographic information.

7. The computer program product of claim 6, further comprising program code to gather data for an event within the boundary and wherein the predicted future behavior is sensitive to the event.

8. The computer program product of claim 7, further comprising program code to predict traffic associated with the event and the boundary responsive to the received demographic information.

9. The computer program product of claim 6, wherein the future behavior is predicted purchasing behavior based on the demographic information.

10. The computer program product of claim 6, further comprising program code to target advertising to the mobile device during an event within the boundary and based on the predicted purchasing behavior.

11. A system comprising:
a processing unit in communication with memory;
a functional unit in communication with the processing unit, the functional unit having tools to apply format attributes to a destination, the tools comprising:
a coordinate manager to ascertain a geo-coordinate boundary of a geographic locale;
a storage manager to gather data associated with a mobile device within the ascertained geo-coordinate boundary, the gathered data including demographic information associated with the mobile device;
an analysis manager to analyze the gathered data; and
a behavior manager to predict a future behavior based on at least one characteristic associated with the demographic information.

12. The system of claim 11, further comprising the storage manager to gather data for an event within the boundary and wherein the predicted future behavior is sensitive to the event.

13. The system of claim 12, further comprising the behavior manager to predict traffic associated with the event and the boundary responsive to the received demographic information.

14. The system of claim 11, wherein the future behavior is predicted purchasing behavior based on the demographic information.
